(19) United States
(12) Patent Application Publication
(10) Pub. No.: US 2002/0048129 A1
(43) Pub. Date: Apr. 25, 2002

(54) Systems and methods for a safety circuit for an electric motor

(76) Inventor: William F. Hackett JR., Mesa (AZ)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/838,004

(22) Filed: Apr. 18, 2001

Related U.S. Application Data
(60) Provisional application No. 60/198,207, filed on Apr. 19, 2000.

(51) Int. Cl. H02H 5/04

(52) U.S. Cl. 361/23

(57) ABSTRACT

A safety circuit for an electric motor. The electric motor includes at least one power input, at least one motor winding and an input ground. The safety circuit includes a relay coupled to the power input and the input ground, and a transistor switch coupled to the relay, the power input and the motor winding. If the relay becomes decoupled from input ground, then the transistor switch will be closed, thus preventing power from the power input from reaching the motor winding.

CROSS-REFERENCES TO RELATED APPLICATIONS

This application claims priority to U.S. Provisional Application No. 60198207, (Attorney Docket No. 1601001000US) filed Apr. 19, 2000 which is herein incorporated by reference for all purposes.

### BACKGROUND OF THE INVENTION

1. Field of the Invention

The present invention is directed to a safety circuit for use in an electric motor, and more particularly, to a safety circuit for an electric motor for use with pumps that prevents operation of the electric motor if the motor's connection to ground is lost.

2. Description of the Prior Art

Currently, pumps are used for many applications. Many of these pumps are powered by electric motors. Since pumps are generally used for pumping liquids and fluids, it is important that the electric motor be coupled to ground in order to help minimize injuries due to electric shock.

Safety laboratories that test and certify electrical products for safety currently look only for the integrity of the electrical insulation in machines. Thus, these machines may operate even if they are not grounded. For obvious reasons, this is unsafe.

Generally, it has been observed that if one deliberately disconnects or inadvertently disconnects the (safety) ground on most operating electrical devices on the market today, that device will continue to operate. For obvious reasons, this is not a desirable situation.

### BRIEF SUMMARY OF THE INVENTION

The present invention provides a safety circuit for an electric motor that includes at least one power input, at least one motor winding and an input ground. The safety circuit includes a relay coupled to the power input and the input ground. At least one transistor switch is coupled to the relay, the power input and the motor winding. If the relay is properly coupled to ground, then the transistor switch will be turned on and current will be allowed to flow between the power input and the motor winding, thus allowing the electric motor to operate. If the relay is not coupled to the input ground, then the transistor switch will be turned off and power will not be allowed to flow between the power input and the motor winding.

In accordance with one aspect of the present invention, the relay comprises an inductor that is inductively coupled to the transistor switch. In accordance with another aspect of the present invention, the relay comprises a resistor that is coupled to the transistor switch.

The present invention also provides a method of operating an electric motor.

Other features and advantages of the present invention will be understood upon reading and understanding the detailed description of the preferred exemplary embodiments found herein below, in conjunction with reference to the drawings, in which like numerals represent like elements.

### BRIEF DESCRIPTION OF THE DRAWING

FIG. 1 is a schematic illustration of a safety circuit for an electric motor in accordance with the present invention.

### DESCRIPTION OF PREFERRED EXEMPLARY EMBODIMENTS

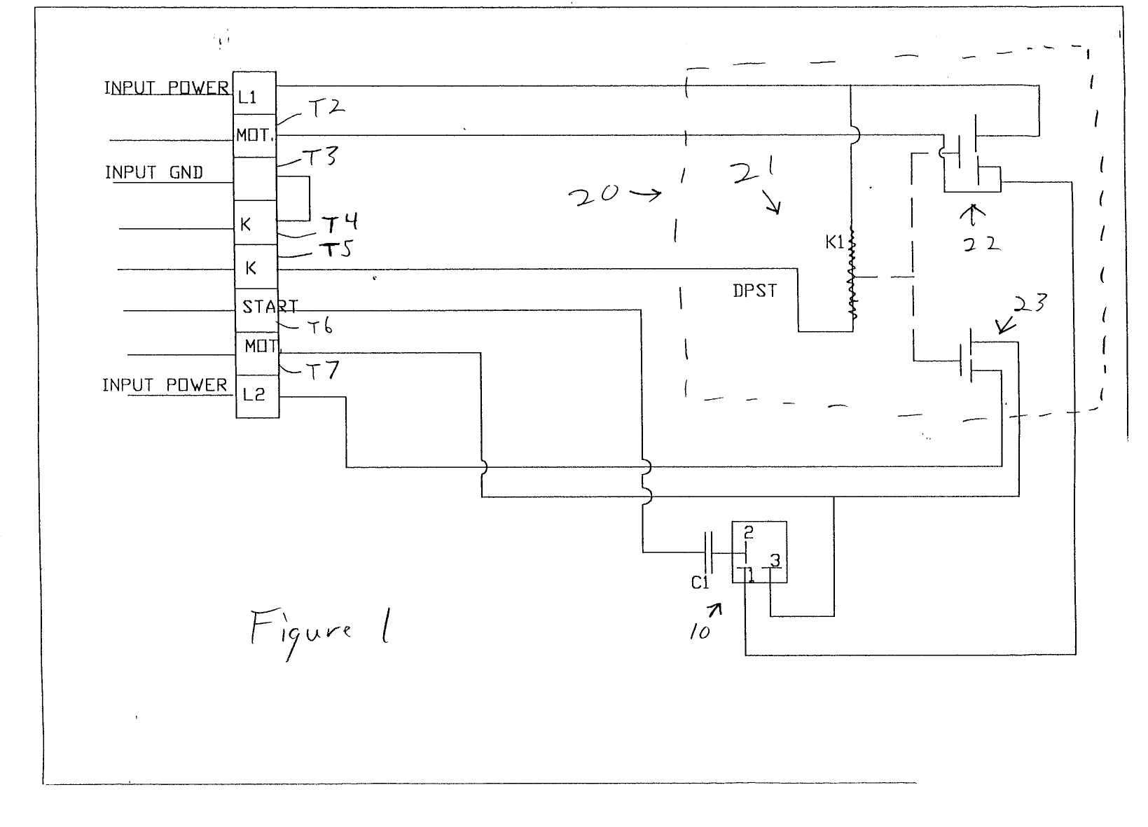

With reference to FIG. 1, a schematic wiring diagram for a control box of an electric motor is illustrated. The electric motor is especially suitable for a pump. However, those skilled in the art will understand that the electric motor and the circuit illustrated in FIG. 1 have many other uses and may be modified according to needs.

L1 and L2 are inputs for input power to the electric motor. Thus, in the present example, the electric motor is a 220 volt motor and L1 and L2 represent 110 volt inputs.

Inputs T2 and T7 are inputs to the motor's winding. Inputs T4 and T5 are preferably coupled to a thermal switch or temperature sensor. As can be seen in FIG. 1, input T3 preferably is coupled to input ground and input T4. T6 is preferably coupled to a starter and starter switch circuit 10.

A safety circuit 20 is also provided. Preferably, the safety circuit includes a relay portion 21 coupled to the input power L1 and L2 and one of the thermal switch terminals (thus, being coupled to ground). Additionally, the safety circuit also preferably includes two transistor switches 22, 23, one of which is coupled to input power L1, while the other is coupled to input power L2.

In the example illustrated in FIG. 1, the relay portion of the safety circuit includes an inductor K1. The inductor is inductively coupled to both of the transistor switches. Thus, when input power is provided in Li, a current flows through the relay branch thus creating current through the inductor. This current through the inductor pulls the gates of the transistor switches high, thus short circuiting the transistors and allowing current to flow from the input power leads to the motor winding leads.

If the ground connection is lost in the relay portion, the current would stop flowing through the relay branch, thus de-energizing the relay inductor coil. Accordingly, the transistor switches would be “closed” since the gates would now be low and current would fail to flow through the transistor switches to the motor winding inputs. Accordingly, the electric motor would not operate.

In an alternative embodiment, the inductor is replaced with a resistor that is directly coupled to the gates of the transistor switches. When current flows through the relay portion, the resistor “opens” the transistor switches by pulling the gates high due to the potential at the resistor. Likewise, if current is not flowing through the resistor, for example, due to the relay portion's connection with ground being lost, then the transistors close.

As can also be seen in FIG. 1, the circuit preferably includes an electronic starter switch circuit 10 coupled to starter input T6 and the transistor switches for manually controlling turning on and off the electric motor. Electronic switch circuit 10 is merely an example of a starter circuit known in the industry.

Although the invention has been described with reference to specific exemplary embodiments, it will be appreciated that it is intended to cover all modifications and equivalents within the scope of the appended claims.

What is claimed is:

1. A safety circuit for an electric motor including at least one power input, at least one motor winding and an input ground, the safety circuit comprising:
a. a relay coupled to the at least one power input and the input ground; and
b. at least one transistor switch coupled to the relay, the at least one power input and the at least one motor winding.

2. A safety circuit in accordance with claim 1 wherein the relay comprises an inductor that is inductively coupled to the at least one transistor switch.

3. A safety circuit in accordance with claim 1 wherein the relay comprises a resistor that is coupled to the at least one transistor switch.

4. A safety circuit for an electric motor including at least first and second power inputs, at least first and second motor windings and an input ground, the safety circuit comprising:
a. a relay coupled to the at least two power inputs and the input ground; and
b. at least first and second transistor switches coupled to the relay, the first transistor switch being coupled the first power input and the first motor winding, and the second transistor switch being coupled to the second power input and the second motor winding.

5. A safety circuit in accordance with claim 4 wherein the relay comprises an inductor that is inductively coupled to the at least first and second transistor switches.

6. A safety circuit in accordance with claim 4 wherein the relay comprises a resistor that is coupled to the at least first and second transistor switches.

7. An electric motor comprising:
a. at least first and second power inputs;
b. at least first and second motor windings;
c. an input ground; and
d. a safety circuit comprising:
i. a relay coupled to the at least two power inputs and the input ground; and
ii. at least first and second transistor switches coupled to the relay, the first transistor switch being coupled the first power input and the first motor winding, and the second transistor switch being coupled to the second power input and the second motor winding.

8. An electric motor in accordance with claim 7 wherein the relay comprises an inductor that is inductively coupled to the at least first and second transistor switches.

9. An electric motor in accordance with claim 7 wherein the relay comprises a resistor that is coupled to the at least first and second transistor switches.

10. A method of operating an electric motor including at least one power input, at least one motor winding and an input ground, the method comprising:
a. providing a safety circuit comprising:
i. a relay coupled to the at least one power input and the input ground; and
ii. at least one transistor switch coupled to the relay, the at least one power input and the at least one motor winding;
b. supplying power to the at least one power input; and
c. ceasing operation of the electric motor if the relay is not coupled to ground.

11. A method in accordance with claim 10 wherein the relay comprises an inductor that is inductively coupled to the at least one transistor switch.

12. A method in accordance with claim 10 wherein the relay comprises a resistor that is coupled to the at least one transistor switch.

13. A method of operating an electric motor including at least first and second power inputs, at least first and second motor windings and an input ground, the method comprising:
a. providing a safety circuit comprising:
i. a relay coupled to the at least first and second power inputs and the input ground; and
ii. at least first and second transistor switches coupled to the relay, the first transistor switch being coupled the first power input and the first motor winding, and the second transistor switch being coupled to the second power input and the second motor winding;
b. supplying power to the at least first and second power inputs; and
c. ceasing operation of the electric motor if the relay is not coupled to ground.

14. A method in accordance with claim 13 wherein the relay comprises an inductor that is inductively coupled to the at least first and second transistor switches.

15. A method in accordance with claim 13 wherein the relay comprises a resistor that is coupled to the at least first and second transistor switches.

16. A pump comprising an electric motor comprising:
a. at least first and second power inputs;
b. at least first and second motor windings;
c. an input ground; and
d. a safety circuit comprising:
i. a relay coupled to the at least two power inputs and the input ground; and
ii. at least first and second transistor switches coupled to the relay, the first transistor switch being coupled the first power input and the first motor winding, and the second transistor switch being coupled to the second power input and the second motor winding.

17. A pump in accordance with claim 16 wherein the relay comprises an inductor that is inductively coupled to the at least first and second transistor switches.

18. A pump in accordance with claim 16 wherein the relay comprises a resistor that is coupled to the at least first and second transistor switches.
